(19) United States
(12) Patent Application Publication
(10) Pub. No.: US 2026/0149335 A1
(43) Pub. Date: May 28, 2026

(54) ELECTRIC MACHINE FOR A MOTOR VEHICLE, COMPRISING A PIEZOELECTRIC BEARING MODULE

(71) Applicant: Continental Automotive Technologies GmbH, Hannover (DE)

(72) Inventors: Eric SENECHAL, Cugnaux (FR); Bertrand VAROQUIE, Eaunes (FR)

(73) Assignee: Continental Automotive Technologies GmbH, Hannover (DE)

(21) Appl. No.: 19/385,284

(22) Filed: Nov. 11, 2025

(30) Foreign Application Priority Data
Nov. 22, 2024 (FR) 2412847

(51) Int. Cl. H02K 11/21; H02J 50/15; H02K 7/08

(52) U.S. Cl. CPC H02K 11/21; H02J 50/15; H02K 7/083

(57) ABSTRACT

An electric machine for a motor vehicle, includes a stator and a rotor mounted on the stator movably in rotation by a rotary shaft and a plurality of bearing modules>A fixed element of at least one bearing module includes a “main” piezoelectric transceiver configured to transmit an ultrasonic power supply signal, and the electric machine includes a sensor mounted inside the rotor.

### CROSS-REFERENCE TO RELATED APPLICATIONS

This application claims priority to French Application No. 2412847, filed Nov. 22, 2024, the contents of such application being incorporated by reference herein.

### FIELD OF THE INVENTION

The present invention relates to the field of motor vehicles and relates more particularly to an electric machine for a motor vehicle comprising a piezoelectric bearing module for measuring parameters such as, for example, the temperature inside the rotor.

### BACKGROUND OF THE INVENTION

As is known, an electric motor includes a rotor and a stator. The operation of such a motor causes the rotor and the stator to heat up. The increase in temperature of the rotor may lead to performance losses and to demagnetization of the magnets placed inside beyond a certain temperature, which can lead to damage or even failure of the motor. It is therefore necessary to measure the temperature inside the rotor in order to enable the speed thereof to be reduced when the temperature approaches the critical operating limit, thereby preventing the motor from being damaged or failing.

The temperature of the rotor is difficult to measure directly using wired temperature sensors because the rotor rotates during operation, and the temperature is therefore estimated using algorithms and models integrated into the management system of the motor.

However, these integrated algorithms and models lead to measurement errors of possibly up to approximately 20° C., which is unsatisfactory for controlling the motor to prevent it from being damaged or failing.

A simple, reliable and efficient solution allowing these drawbacks to be at least partly overcome would therefore be advantageous.

### SUMMARY OF THE INVENTION

For this purpose, an aspect of the invention first of all relates to an electric machine for a motor vehicle, said electric machine comprising a stator and a rotor mounted on said stator movably in rotation by means of a rotary shaft and a plurality of bearing modules, each bearing module comprising a fixed element mounted on the stator, a movable element mounted on the rotor, at least one rolling element mounted between the fixed element and the movable element and configured to allow the rotor to rotate relative to the stator, the electric machine being noteworthy in that:
a fixed element of at least one bearing module comprises a “main” piezoelectric transceiver that is configured to transmit an ultrasonic power supply signal,
the stator comprises a control stage configured to command said main piezoelectric transceiver to transmit,
the electric machine comprises a sensor, mounted inside the rotor, comprising a “remote” piezoelectric transceiver, a measurement stage and a sensing element, said remote piezoelectric transceiver being configured to receive the ultrasonic power supply signal and to transmit it to the measurement stage, the measurement stage being configured to harvest and store the electrical energy contained in the received ultrasonic power supply signal and to electrically power the sensing element using the stored electrical energy, the sensing element being configured to measure a parameter inside the rotor, to generate a measurement signal including at least one value of the measured parameter and to transmit said generated measurement signal to the measurement stage, the measurement stage being configured to extract the at least one value of the measured parameter contained in the measurement signal, to generate an ultrasonic response signal including the at least one extracted value of the parameter, and to command the remote piezoelectric transceiver to transmit said generated ultrasonic response signal, the main piezoelectric transceiver being configured to receive said ultrasonic response signal and to transmit said received ultrasonic response signal to the control stage, said control stage being configured to extract the at least one value of the parameter contained in the transmitted ultrasonic response signal.

The device according to an aspect of the invention is used to take remote measurements with the remote module by powering the sensing measurement element with the energy from signals sent by the main module over a wireless link. This enables the measurements to be taken as close as possible to the magnets, thereby enhancing control performance of the electric machine. The An aspect of invention also makes it possible to cross metal barriers such as, for example, the casing and the protective flanges, which block electromagnetic Wi-Fi or Bluetooth waves. Placing the main piezoelectric transmitter in the fixed portion attached to the stator allows the signals to be efficiently transmitted to the sensor, said signals no longer being attenuated by the bearing module.

In one embodiment, the main piezoelectric transceiver has an elongate shape in a longitudinal direction parallel to the rotary shaft of the rotor to control the transmission rate of the ultrasonic signals through the bearing module and to allow the operating mode to be selected.

In another embodiment, the main piezoelectric transceiver has an elongate shape in a longitudinal direction orthogonal to the rotary shaft of the rotor to control the transmission rate of the ultrasonic signals through the bearing module and to allow the operating mode to be selected.

Advantageously, each bearing module is circular and entirely surrounds the rotary shaft of the rotor.

Preferably, each bearing module is a roller bearing or a ball bearing.

In one embodiment, the main piezoelectric transceiver is made of ceramic.

In one embodiment, the sensor further comprising an external communication stage, the measurement stage may be configured to command the transmission of signals containing the measured values via said external communication stage. The measured values can thus be sent to an entity outside the measurement device for processing. The external communication stage may for example transmit using a Bluetooth, Wi-Fi, 5G or RFID communication protocol.

In one embodiment, the main piezoelectric transceiver being configured to resonate at at least one predetermined frequency, the control stage is configured to generate a signal at said at least one predetermined frequency and to deliver the generated signal to the main piezoelectric transceiver, and the remote piezoelectric transceiver is configured to resonate at said at least one predetermined frequency. These technical features enable selectivity in communication and in particular enable several sensors to be used with a single main piezoelectric transceiver, which improves performance and allows the frequency to be adjusted depending on the specific modes of the electric machine and on the acoustic reflections.

Advantageously, the control stage is configured to control the position of the rotor depending on the at least one extracted value of the parameter.

An aspect of invention also relates to a motor vehicle comprising an electric machine as set out above, said electric machine being configured to drive the wheels of said vehicle in rotation.

An aspect of invention also relates to a method for measuring a parameter in a rotor of an electric machine of a motor vehicle, said method comprising the following steps:
the control stage commands the main piezoelectric transceiver to transmit,
the main piezoelectric transceiver transmits an ultrasonic power supply signal,
the remote piezoelectric transceiver receives the transmitted ultrasonic power supply signal,
the measurement stage harvests and stores the electrical energy contained in the received ultrasonic power supply signal,
the measurement stage electrically powers the sensing element using the stored electrical energy,
the sensing element measures the parameter,
the sensing element generates a measurement signal including at least one value of the measured parameter,
the sensing element transmits the generated measurement signal to the measurement stage,
the measurement stage extracts the at least one value of the measured parameter contained in the transmitted measurement signal,
the measurement stage generates an ultrasonic response signal including the at least one extracted value of the parameter,
the measurement stage commands the remote piezoelectric transceiver to transmit said generated ultrasonic response signal,
the remote piezoelectric transceiver transmits said generated ultrasonic response signal,
the main piezoelectric transceiver receives the transmitted ultrasonic response signal,
the main piezoelectric transceiver transmits the received ultrasonic response signal to the control stage,
the control stage extracts the at least one value of the parameter contained in the transmitted ultrasonic response signal.

Advantageously, the method comprises a step in which the control stage controls the position of the rotor on the basis of the at least one extracted value of the parameter.

### BRIEF DESCRIPTION OF THE DRAWINGS

Other features and advantages of aspects of the invention will become more apparent upon reading the following description. It is purely illustrative and should be read with reference to the appended drawings, in which:

FIG. 1 is a schematic cross-sectional view of an example electric machine according to an aspect of the invention.

FIG. 2 functionally and schematically illustrates a first embodiment of the electric machine according to the invention.

FIG. 3 functionally and schematically illustrates a second embodiment of the electric machine according to the invention.

FIG. 4 is a schematic cross-sectional view of a first example bearing module of an electric machine according to an aspect of the invention.

FIG. 5 is a schematic cross-sectional view of a second example bearing module of an electric machine according to an aspect of the invention.

FIG. 6 is a schematic cross-sectional view of a third example bearing module of an electric machine according to an aspect of the invention.

FIG. 7 schematically illustrates an embodiment of the method according to an aspect of the invention.

### DETAILED DESCRIPTION OF EXEMPLARY EMBODIMENTS

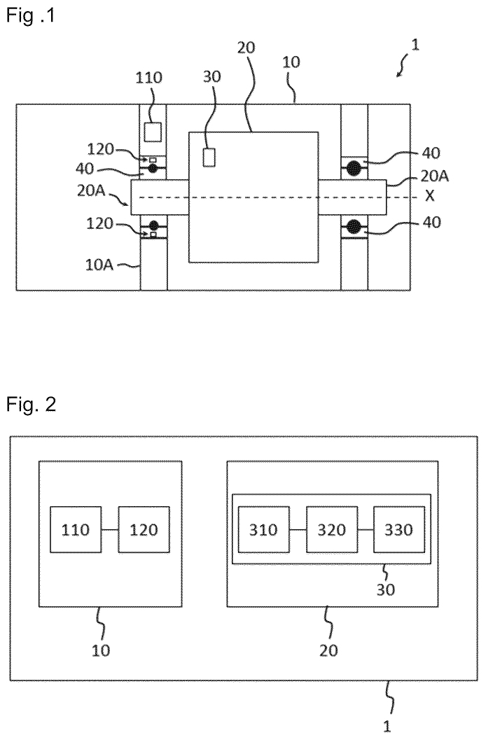

FIG. 1 shows an example electric machine 1 according to an aspect of the invention. The electric machine 1 is intended to be mounted in a motor vehicle to drive the wheels thereof in rotation.

The electric machine 1 comprises a stator 10 and a rotor 20 mounted movably in rotation on said stator 10.

The stator 10 comprises a control stage 110 and a main piezoelectric transceiver 120.

The control stage 110 is configured to command said main piezoelectric transceiver 120 to transmit.

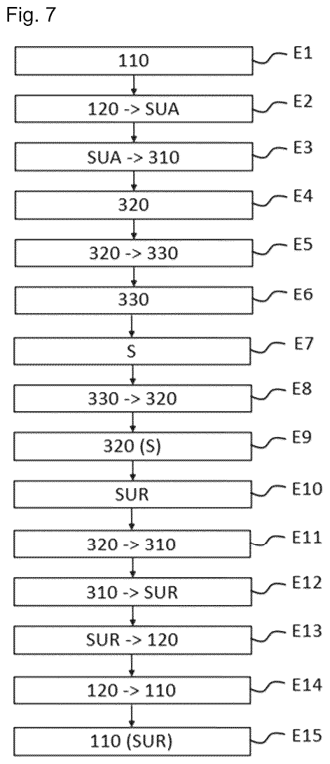

The main piezoelectric transceiver 120 is configured to transmit an ultrasonic “power supply” signal SUA (FIG. 7) and to receive an ultrasonic “response” signal SUR (FIG. 7).

The electric machine 1 also comprises a sensor 30, mounted inside the rotor 20.

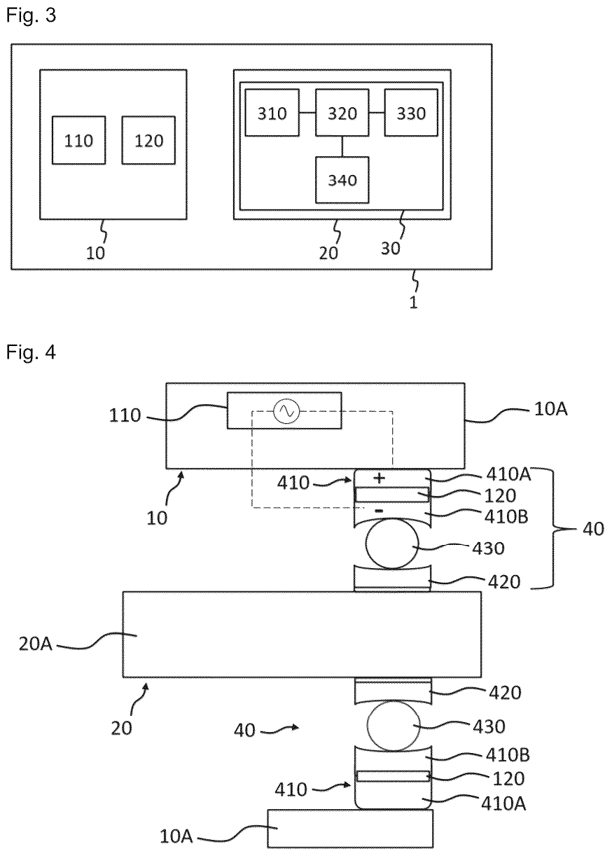

With reference to FIGS. 2 and 3, the sensor 30 comprises a “remote” piezoelectric transceiver 310, a measurement stage 320 and a sensing element 330.

The remote piezoelectric transceiver 310 is configured to receive the ultrasonic power supply signal SUA and to transmit it to the measurement stage 320.

The measurement stage 320 is configured to harvest and store the electrical energy contained in the received ultrasonic power supply signal SUA and to electrically power the sensing element 330 using the stored electrical energy.

The sensing element 330 is configured to measure a parameter inside the rotor 20, to generate a measurement signal S (FIG. 7) including at least one value of the measured parameter, and to transmit said generated measurement signal S to the measurement stage 320.

The measurement stage 320 is configured to extract the at least one value of the measured parameter contained in the measurement signal S, to generate an ultrasonic response signal SUR including the at least one extracted value of the parameter, and to command the remote piezoelectric transceiver 310 to transmit said generated ultrasonic response signal SUR to the main piezoelectric transceiver 120.

The main piezoelectric transceiver 120 is configured to receive said ultrasonic response signal SUR and to transmit said received ultrasonic response signal SUR to the control stage 110.

The control stage 110 is configured to extract the at least one value of the parameter contained in the transmitted ultrasonic response signal SUR and to control the position of the rotor 20 on the basis of the at least one extracted value of the parameter.

In one embodiment, illustrated in FIG. 3, the sensor 30 comprises an external communication stage 340 and the measurement stage 320 is configured to command the transmission of signals containing the measured parameter values (extracted from the measurement signal S) via said external communication stage 340. This transmission may for example be carried out over a Bluetooth or RFID communication interface, which are known. In this case, the external communication stage 340 preferably comprises a microcontroller used to implement this transmission function.

In one embodiment:
the main piezoelectric transceiver 120 is configured to resonate at at least one predetermined frequency, preferably at two predetermined frequencies, for example 200 kHz and 2 MHz,
the control stage 320 is configured to generate a signal at said at least one predetermined frequency and to deliver the generated signal to the main piezoelectric transceiver 120, and
the remote piezoelectric transceiver 310 is configured to resonate at said at least one predetermined frequency, in order to improve the quality of the ultrasonic signals transmitted between the main piezoelectric transceiver 120 and the remote piezoelectric transceiver 310.

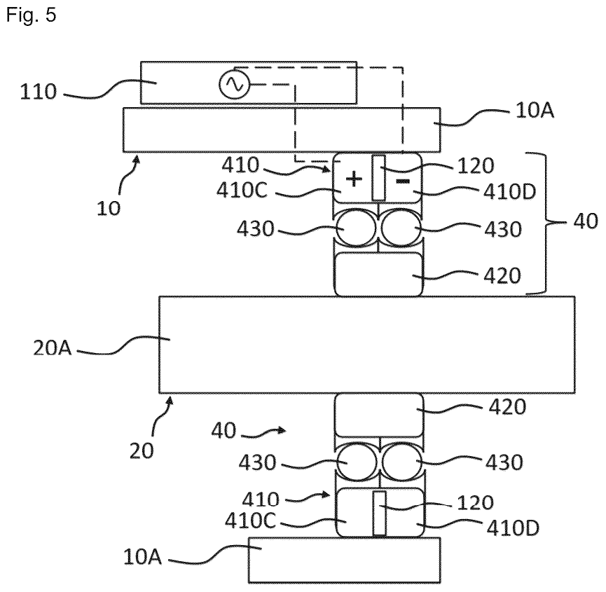

With reference now to FIGS. 1, 4, 5 and 6, the stator 10 comprises an armature 10A and the rotor 20 comprises a rotary shaft 20A which allows the rotor 20 to be mounted movably in rotation on the stator 10 via a plurality of bearing modules 40, only one of which is shown in FIGS. 4 and 5 for the sake of clarity, in a known manner.

There must be at least two bearing modules 40 that are circular, i.e. that completely surround the rotary shaft 20A of the rotor 20, or at least two sets of three journal bearing modules 40, in order to support the rotor 20.

In the examples in FIGS. 4, 5 and 6, the bearing module 40 is circular and comprises a fixed element 410, a movable element 420 and a plurality of rolling elements 430.

In this example, the fixed element 410 is a ring mounted on the armature 10A of the stator 10.

The movable element is also a ring mounted on the rotary shaft 20A of the rotor 20.

The rolling elements 430 are balls mounted between the fixed element 410 and the movable element 420, in a known manner, to enable the rotor 20 to rotate relative to the stator 10.

The fixed element 410 comprises the main piezoelectric transceiver 120. The main piezoelectric transceiver 120 is made of ceramic and extends through the middle of the fixed element 410.

In the example in FIG. 4, the main piezoelectric transceiver 120 is a ring positioned coaxially relative to the rotary shaft 20A of the rotor 20, and the material thereof extends along its rotary shaft, i.e. parallel to the rotary shaft 20A of the rotor 20. The bearing module 40 comprises a set of balls that extend in a plane orthogonal to the rotary shaft of the rotor 20. The main piezoelectric transceiver 120 is mounted between the upper portion 410A of the fixed element 410 and the lower portion 410B of the fixed element 410. The upper portion 410A of the fixed element 410 located between the stator 10 and the main piezoelectric transceiver 120 forms the positive terminal used to receive the electric current from the control stage 110, while the lower portion 410B of the fixed element 410 located between the main piezoelectric transceiver 120 and the rolling element 430 constitutes the negative terminal used to cause the electric current coming from the main piezoelectric transceiver 120 to flow toward the control stage 110.

In the example in FIG. 5, the main piezoelectric transceiver 120 is a ring positioned coaxially relative to the rotary shaft 20A of the rotor 20, and the material thereof extends orthogonal to its rotary shaft, i.e. orthogonal to the rotary shaft 20A of the rotor 20. The bearing module 40 comprises two sets of balls that are arranged vertically and in parallel. The main piezoelectric transceiver 120 is mounted between the left-hand portion 410C of the fixed element 410 and the right-hand portion 410D of the fixed element 410. The left-hand portion 410C of the fixed element 410 forms the positive terminal used to receive the electric current from the control stage 110, while the right-hand portion 410D of the fixed element 410 forms the negative terminal used to cause the electric current coming from the main piezoelectric transceiver 120 to flow toward the control stage 110.

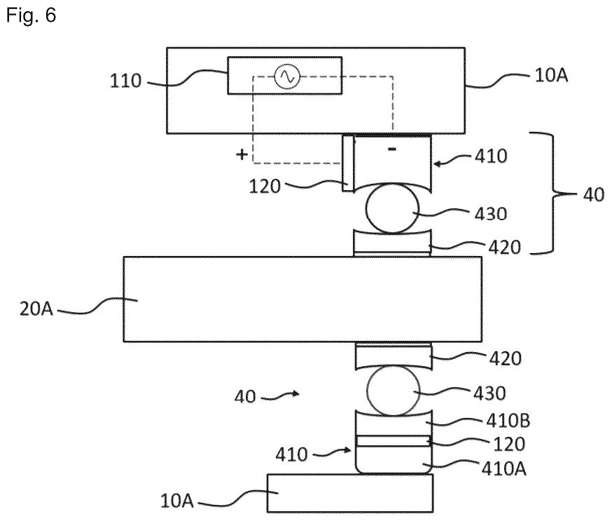

In the example in FIG. 6, the main piezoelectric transceiver 120 is a ring positioned coaxially relative to the rotary shaft 20A of the rotor 20, and the material thereof extends orthogonal to its rotary shaft, i.e. orthogonal to the rotary shaft 20A of the rotor 20. The ring is mounted on a lateral face of the fixed element 410. The ring may be mounted by adhesive bonding, crimping or by screws or any equivalent fastening means.

### Example of Implementation

One example of implementation of the electric machine 1 will now be described with reference to FIG. 7. In this non-limiting example, the parameter to be measured may for example be the temperature inside a rotor 20A of the electric machine 20.

First of all, when the parameter has to be measured, the control stage 110 commands, in a step E1, the piezoelectric transmitter 120 to transmit ultrasonic signals.

The main piezoelectric transceiver 120 transmits, in a step E2, an ultrasonic power supply signal SUA to the remote piezoelectric transceiver 310, which receives it in a step E3.

In a step E4, the measurement stage 320 of the sensor 30 harvests and stores the electrical energy contained in the received ultrasonic power supply signal SUA, for example in a capacitor, and electrically powers the sensing element 330 using the stored electrical energy in a step E5.

The sensing element 330 measures the parameter, for example the temperature, in a step E6 and then generates a measurement signal S including at least one value of the measured parameter in a step E7.

The sensing element 330 then transmits, in a step E8, the generated measurement signal S to the measurement stage 320 which receives it and extracts the at least one value of the measured parameter contained in the measurement signal S in a step E9.

The measurement stage 320 then generates, in a step E10, an ultrasonic response signal SUR including the at least one extracted value of the parameter and then commands the remote piezoelectric transceiver 310 to transmit said generated ultrasonic response signal SUR in a step E11.

The remote piezoelectric transceiver 310 transmits, in a step E12, the generated ultrasonic response signal SUR, which is received by the main piezoelectric transceiver 120 in a step E13.

The main piezoelectric transceiver 120 then transmits, in a step E14, the received ultrasonic response signal SUR to the control stage, which extracts the at least one value of the parameter contained in said transmitted ultrasonic response signal in a step E15 and then optionally controls the position of the rotor 20 depending on said at least one value of the measured parameter, for example to slow down the rotor 20 and to prevent it from being damaged when the temperature measured inside the rotor is too high.

The invention therefore enables a parameter to be measured using a remote module that is remotely supplied with electrical energy, thus obviating the need to use a battery which has to be changed, which is particularly advantageous in the case of a rotor of an electric machine, while allowing efficient transmission of the signals between the control stage 110 and the sensor 30.

1. An electric machine for a motor vehicle, said electric machine comprising a stator and a rotor mounted on said stator movably in rotation by means of a rotary shaft and a plurality of bearing modules, each bearing module comprising a fixed element mounted on the stator, a movable element mounted on the rotor, at least one rolling element mounted between the fixed element and the movable element and configured to allow the rotor to rotate relative to the stator, the electric machine being characterized in that:
a fixed element of at least one bearing module comprises a “main” piezoelectric transceiver that is configured to transmit an ultrasonic power supply signal,
the stator comprises a control stage configured to command said main piezoelectric transceiver to transmit,
the electric machine comprises a sensor, mounted inside the rotor, comprising a “remote” piezoelectric transceiver, a measurement stage and a sensing element, said remote piezoelectric transceiver being configured to receive the ultrasonic power supply signal and to transmit it to the measurement stage, the measurement stage being configured to harvest and store the electrical energy contained in the received ultrasonic power supply signal and to electrically power the sensing element using the stored electrical energy, the sensing element being configured to measure a parameter inside the rotor, to generate a measurement signal including at least one value of the measured parameter and to transmit said generated measurement signal to the measurement stage, the measurement stage being configured to extract the at least one value of the measured parameter contained in the measurement signal, to generate an ultrasonic response signal including the at least one extracted value of the parameter, and to command the remote piezoelectric transceiver to transmit said generated ultrasonic response signal, the main piezoelectric transceiver being configured to receive said ultrasonic response signal and to transmit said received ultrasonic response signal to the control stage, said control stage being configured to extract the at least one value of the parameter contained in the transmitted ultrasonic response signal.

2. The electric machine as claimed in claim 1, wherein the main piezoelectric transceiver has an elongate shape in a longitudinal direction parallel to the rotary shaft of the rotor.

3. The electric machine as claimed in claim 1, wherein the main piezoelectric transceiver has an elongate shape in a longitudinal direction orthogonal to the rotary shaft of the rotor.

4. The electric machine claimed in claim 1, wherein each bearing module is circular and entirely surrounds the rotary shaft of the rotor.

5. The electric machine as claimed in claim 1, wherein each bearing module is a roller bearing or a ball bearing.

6. The electric machine as claimed in claim 1, wherein the main piezoelectric transceiver is made of ceramic.

7. The electric machine as claimed in claim 1, wherein the control stage is configured to control the position of the rotor depending on the at least one extracted value of the parameter.

8. A motor vehicle comprising an electric machine s claimed in claim 1, said electric machine being configured to drive the wheels of said vehicle in rotation.

9. A method for measuring a parameter in a rotor of an electric machine of a motor vehicle, said method comprising
the control stage commands the main piezoelectric transceiver transmit,
the main piezoelectric transceiver transmits an ultrasonic power supply signal,
the remote piezoelectric transceiver receives the transmitted ultrasonic power supply signal
the measurement stage harvests and stores the electrical energy contained in the received ultrasonic power supply signal,
the measurement stage electrically powers the sensing element using the stored electrical energy,
the sensing element measures the parameter,
the sensing element generates a measurement signal including at least one value of the measured parameter,
the sensing element transmits the generated measurement signal the measurement stage,
the measurement stage extracts the at least one value of the measured parameter contained in the transmitted measurement signal,
the measurement stage generates an ultrasonic response signal including the at least one extracted value of the parameter,
the measurement stage commands the remote piezoelectric transceiver to transmit said generated ultrasonic response signal,
the remote piezoelectric transceiver transmits said generated ultrasonic response signal,
the main piezoelectric transceiver receives the transmitted ultrasonic response signal,
the main piezoelectric transceiver transmits the received ultrasonic response signal to the control stage,
the control stage extracts the at least one value of the parameter contained in the transmitted ultrasonic response signal.
